(19) United States
(12) Patent Application Publication
(10) Pub. No.: US 2026/0254218 A1
(43) Pub. Date: Aug. 27, 2026

(54) FLOATING TOW ARM FOR SECTIONAL DOOR WITH CABLE CARRIER FOR POWER CABLE

(71) Applicant: Clopay Corporation, Mason, OH (US)

(72) Inventors: Brian David Cranston, Morrow, OH (US); Canas Rueben Bellamy, Hamilton, OH (US); Justin Guilfoyle, Harrison, OH (US); Thomas Edward Youtsey, Wilder, KY (US)

(73) Assignee: Clopay Corporation, Mason, OH (US)

(21) Appl. No.: 19/539,451

(22) Filed: Feb. 13, 2026

Related U.S. Application Data
(60) Provisional application No. 63/762,601, filed on Feb. 24, 2025.

(51) Int. Cl. H02G 3/22; E06B 3/48; E06B 3/70; H02G 3/04

(52) U.S. Cl. CPC H02G 3/22; E06B 3/485; E06B 3/7001; H02G 3/0475; E05Y 2900/106

(57) ABSTRACT

In example implementations, a floating tow arm for a floating tow arm assembly of an overhead door is provided. The floating tow arm includes a curved body. The curved body includes a first end that includes a first opening to receive a first mechanical fastener to couple at least one roller to the first end and a second end that includes one or more second openings to receive second mechanical fasteners to couple a cable chain attachment to the second end.

### CROSS REFERENCE TO RELATED APPLICATIONS

This application claims priority to United States Provisional Patent Application Serial No. 63/762,601, filed Feb. 24, 2025, which are all herein incorporated by reference in its entirety.

### BACKGROUND

Doors can be used for a variety of applications. For example, doors can be used in residential locations or doors for bays and entrances to warehouses in commercial locations. Some doors may include sectional doors. One type of sectional door may be garage doors.

Sectional doors may be made from a plurality of individual sections that are mechanically coupled together. The size and number of sections may be determined based on a size of the opening of the garage or any other type of location with an opening. Each section may have a wheel that can fit into a track. The track may guide movement of each section of the sectional door while opening and closing. The sectional door can be opened and closed manually with the help of a loaded torsion spring or mechanically via a motor or garage door opener.

### BRIEF DESCRIPTION OF THE DRAWINGS

FIG. 1 illustrates a block diagram of an example sectional door with the cable carrier of the present disclosure;

FIG. 2 illustrates a close up view of an example of a cable carrier track, the cable carrier, and a sectional cable carrier guide on a top section of the sectional door of the present disclosure;

FIG. 3 illustrates a cross-sectional view of an example cable carrier track of the present disclosure;

FIG. 4 illustrates a top back isometric view of an example of the sectional cable carrier guide of the present disclosure;

FIG. 5 illustrates a top front isometric view of an example of the sectional cable carrier guide of the present disclosure;

FIG. 6 illustrates a bottom front isometric view of an example of the sectional cable carrier guide of the present disclosure;

FIG. 7 illustrates a cut-away view of an example of the sectional cable carrier guide of the present disclosure and how the power cable is fed into the top panel of the sectional door;

FIG. 8 illustrates another example of the cable carrier track of the present disclosure;

FIG. 9 illustrates an example of a cable carrier of the present disclosure;

FIG. 10 illustrates an isometric view of an example floating tow arm in a first configuration of the present disclosure;

FIG. 11 illustrates an isometric view of an example floating tow arm in a second configuration of the present disclosure;

FIG. 12 illustrates a close-up view of an example floating tow arm of the present disclosure;

FIG. 13 illustrates an isometric view of an example tandem roller of the present disclosure;

FIG. 14 illustrates an isometric view of an example first cable chain piece of the present disclosure;

FIG. 15 illustrates an isometric view of an example cable chain attachment of the present disclosure;

FIG. 16 illustrates an exploded view of an example floating tow arm assembly in the first configuration of the present disclosure with a tandem roller;

FIG. 17 illustrates an isometric view of the floating tow arm of the present disclosure;

FIG. 18 illustrates an exploded view of another example floating tow arm assembly in the first configuration of the present disclosure with a single roller;

FIG. 19 illustrates an isometric view of the floating tow arm in a second orientation of the present disclosure;

FIG. 20 illustrates an exploded view of an example floating tow arm assembly in the second configuration of the present disclosure with a tandem roller;

FIG. 21 illustrates an isometric view of another example of a floating tow arm; and

FIG. 22 illustrates an exploded view of an example floating tow arm assembly using the floating tow arm illustrated in FIG. 21.

### DETAILED DESCRIPTION

Examples described herein provide examples of a sectional door with a cable carrier for power cables. As discussed above, doors can be used for a variety of different applications. Some doors may be sectional doors, such as those used as garage doors.

Some sectional doors may include panels with an electronic component. Providing continuous power to the panels can be difficult as the sectional door may move along a track. The movement of the sectional door and the various components of the track may make it difficult to wire the sectional door for power. The wire may become tangled or stuck along the various components of the sectional door and/or track.

The present disclosure provides a cable carrier design that allows wiring for continuous power to a sectional door. The cable carrier design of the present disclosure can provide continuous power without impeding operation of the sectional door. For example, the cable carrier design of the present disclosure avoids getting tangled or caught in the sectional door and/or track of the sectional door.

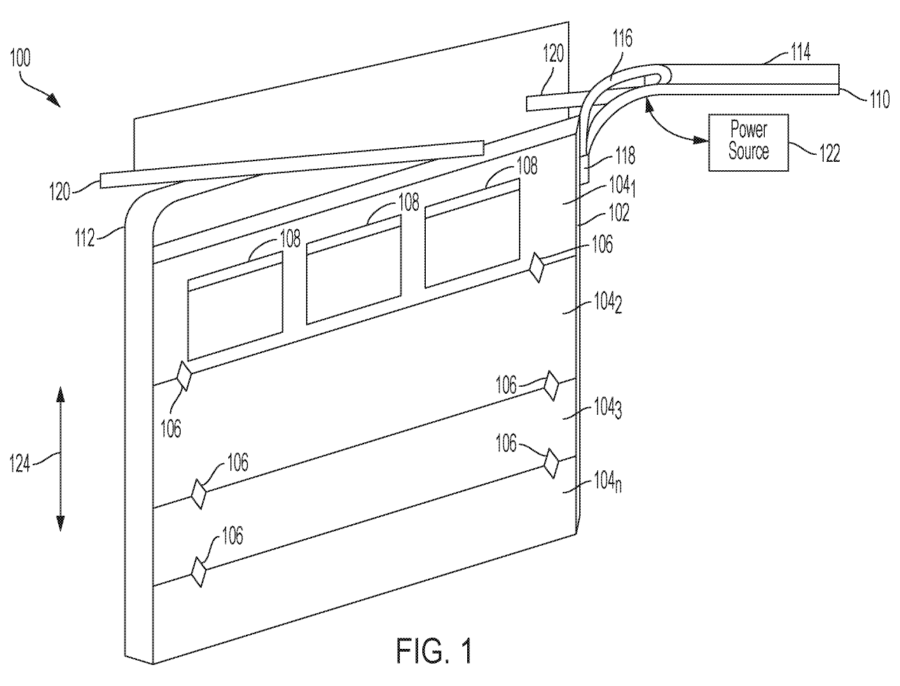

FIG. 1 illustrates a block diagram of a sectional door assembly 100 of the present disclosure. It should be noted that the sectional door assembly 100 in FIG. 1 has been simplified for ease of explanation. The sectional door assembly 100 may include additional features that are not shown. For example, the sectional door 100 may include a rotating shaft, torsion springs, an operator, a user interface to control operation of the sectional door, one or more sensors, and the like.

In one embodiment, the sectional door assembly 100 may include a sectional door 102 that comprises a plurality of panels or sections 104₁to 104ₙ (hereinafter also referred to individually as a panel 104 or collectively as panels 104). The panels may be movably connected to one another via mechanical hinges 106. One or more hinges 106 may be coupled to adjacent panels 104. The first panel 104₁ may be the top most panel 104 and the last panel 104ₙ may be the bottom most panel 104.

In one embodiment, some of the panels 104 may include an electronic component 108 that requires continuous power. As noted above, delivering continuous power to an electronic component 108 within a panel 104 may be difficult. For example, traditional wiring directly to the panel may become tangled or interfere with proper operation of the sectional door 102.

The sectional door 102 may be guided by tracks 110 and 112. The tracks 110 and 112 may be installed on opposite sides of the sectional door 102. A wheel (not shown) may be inserted into the tracks 110 and 112. In the case of a garage door, the garage door may have wheels that move within the tracks 110 and 112 as the garage door opens and closes in a direction as shown by an arrow 124.

The tracks 110 and 112 may be coupled to a wall of an opening where the sectional door 102 is installed. Horizontal angle brackets 121 may be coupled to a flag bracket (not shown) that is attached to the wall may further help to stabilize the tracks 110 and 112.

In one embodiment, the sectional door 102 may include a cable carrier assembly. The cable carrier assembly may include a cable carrier track 114, a cable carrier 116, and sectional cable carrier guide 118. The cable carrier assembly may provide a way to provide power to the electronic component 108 of a panel 104 of the sectional door 102. For example, wiring or a power cable may connect a power source 122 to the panel 104. The wiring may be fed through the cable carrier 116 and the sectional cable carrier guide 118 into an opening in the panel 104. While the phrase “cable carrier” is used herein, the specific structure known as a cable carrier or cable carrier assembly may also be a conduit structure of any type that provides a containment structure for the wiring that is capable of moving within the cable carrier track 114.

The cable carrier assembly may be designed such that the electrical wiring or power cable does not interfere with operation of the sectional door 102. In other words, the cable carrier assembly may prevent the electrical wiring from getting tangled or caught in the track 110 or track 112 while the sectional door 102 is opening and closing.

The cable carrier 116 may be selected to provide appropriate durability. Suitable materials may include, nylon, steel, or aluminum. The structure of the cable carrier 116 may be selected to provide movement through multiple planes of movement such as that traveled by the sectional door 102 within the track 110 or track 112, such as a reverse bending radius cable carrier. Dampening elements may be added to reduce the noise of the cable carrier 116. Magnetic features may allow the cable carrier 116 to follow the interior surface of the cable carrier track 114, discussed further below.

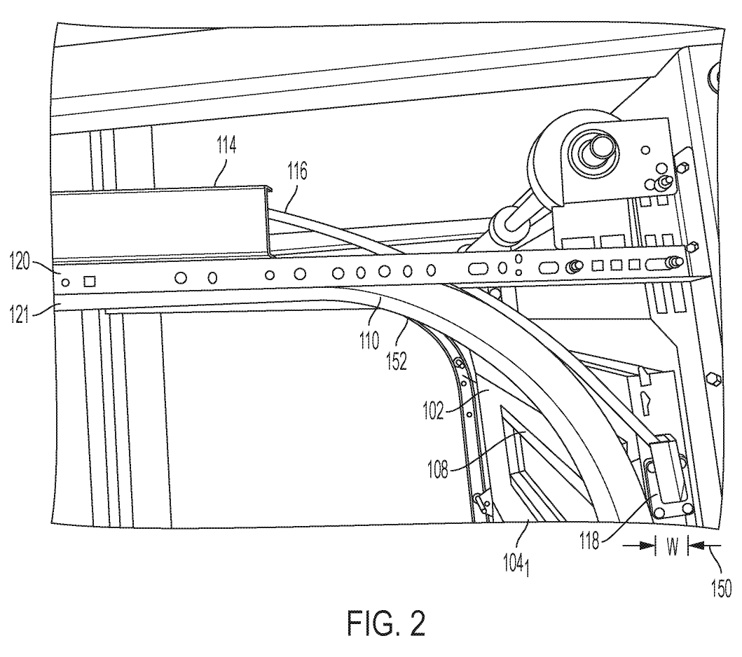

FIG. 2 illustrates a close up view of an example of the cable carrier track 114, the cable carrier 116, and the sectional cable carrier guide 118. FIG. 2 illustrates how the cable carrier track 114, the cable carrier 116, and the sectional cable carrier guide 118 may be arranged on the sectional door assembly 100.

In one embodiment, the cable carrier track 114 may be coupled to one of the tracks 110 or 112. In the example illustrated in FIG. 2, the cable carrier track 114 is coupled to the track 110. However, it should be noted that the cable carrier track 114 may also be coupled to the track 112.

The cable carrier track 114 may be coupled to a horizontal portion 120 of the track 110. The horizontal portion 120 may be a portion of the track 110 that is parallel to the floor or ground and is located on a highest point of the track 110.

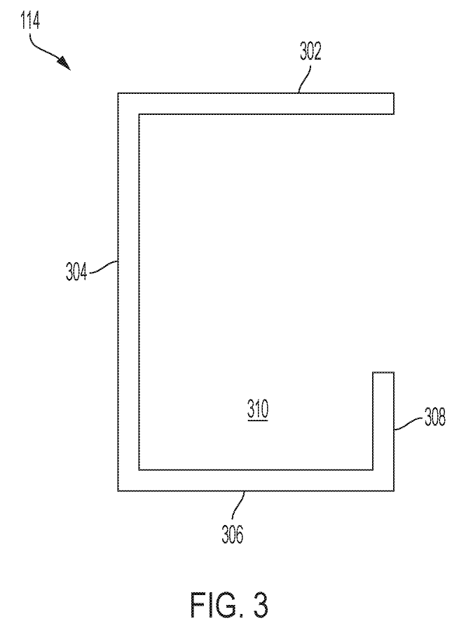

FIG. 3 illustrates a cross-sectional view of an example of the cable carrier track 114. The cable carrier track 114 may be fabricated from steel or metal. The cable carrier track 114 may be formed as separate components that are coupled together or may be fabricated, formed and/or molded by a single piece of metal or steel.

In one embodiment, the cable carrier track 114 may include a first horizontal member 302, a vertical member 304, a second horizontal member 306, and a lip 308. The first horizontal member 302 and the second horizontal member 306 may be parallel. The vertical member 304 and the lip 308 may be parallel. The first horizontal member 302 and the second horizontal member 306 may be normal or perpendicular to the vertical member 304 and the lip 308. The first horizontal member 302, the vertical member 304, the second horizontal member 306, and the lip 308 may form an inner volume 310. The cable carrier 116 may be located inside of the inner volume 310.

In one embodiment, the vertical member 304, the second horizontal member 306, and the lip 308 may form a “J” shaped enclosure. The cross-sectional “J” shape of the cable carrier track 114 may prevent kinks from forming in the cable carrier 116 as the cable carrier 116 moves back and forth within the cable carrier track 114. The first horizontal member 302 and the second horizontal member 306 may help guide movement of the cable carrier 116 within the cable carrier track 114 as the sectional door 102 opens and closes. In an optional embodiment, an inner surface of the cable carrier track 114 may comprise a texture or structure to interlock with the cable carrier 116 sections. The cable carrier 116 may then travel in a desired and repeatable way and may further provide quiet operation when traveling within the cable carrier track 114.

Referring back to FIG. 2, a first end of the cable carrier 116 may be coupled to the cable carrier track 114. For example, the first end of the cable carrier 116 may be coupled to the second horizontal member 306 (shown in FIG. 3) of the cable carrier track 114.

A second end of the cable carrier 116 may be coupled to the sectional cable carrier guide 118. FIG. 2 illustrates the sectional cable carrier guide 118 being coupled to the top most panel 104₁. Although, the sectional cable carrier guide 118 may be coupled to any panel 104 of the sectional door 102, it may be beneficial to couple the sectional cable carrier guide 118 to the top most panel 104₁. Placing the sectional cable carrier guide 118 to the top most panel 104₁may protect the electrical wiring or power cable from interference or obstructions during normal operation where items may be placed to the left or right of the door opening that could fall into the cable carrier track 114.

The sectional cable carrier guide 118 provides a transition for the electrical wires to the electronic component 108 of a panel 104 of the sectional door 102 and a detachable connection point for the second end of the cable carrier 116. The sectional cable carrier guide 118 may be integral with the panel 104 or a component of the panel 104. In one embodiment, the sectional cable carrier guide 118 may be a component of the end stile of the panel 104. The end stile may comprise a channel structure to engage the panel structure (and thereby providing a surface for mounting roller hinges, bottom brackets, top brackets or struts) and a transition structure extending from the end stile surface that allows for the connection of the end of the sectional cable carrier guide 118 and for electrical wires to transition from sectional cable carrier guide 118 through the end stile and into the panel 104. In an embodiment, the sectional cable carrier guide 118 may be a separate structure that is mounted to the panel 104 or a component of the panel 104, such as the end stile.

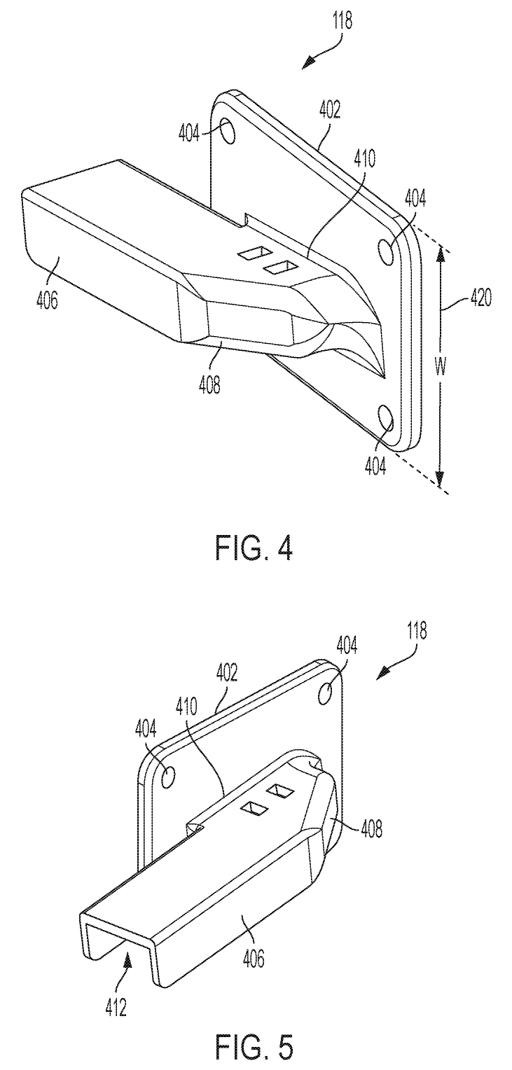

FIGS. 4-6 illustrate various views of an example of the sectional cable carrier guide 118. FIG. 4 illustrates a top back isometric view of an example of the sectional cable carrier guide 118. The sectional cable carrier guide 118 may include a base plate 402 that includes a plurality of openings 404. The base plate 402 may be placed adjacent or on a side of the panel 104 of the sectional door 102. The openings 404 may be aligned with corresponding openings on the panel 104. A mechanical fastener (not shown) may be used to then couple the sectional cable carrier guide 118 to the side of the panel 104. The mechanical fastener may be a threaded screw, a nail, a nut and bolt, and the like.

A width 420 of the base plate 402 may be less than a width 150 of the panel 104 (shown in FIG. 2). Thus, the dimensions of the sectional cable carrier guide 118 may not interfere with proper operation of the sectional door 102.

In one embodiment, the sectional cable carrier guide 118 may include a vertical portion 406, an angled portion 408, and a horizontal portion 410. The vertical portion 406, the angled portion 408, the horizontal portion 410, and the base plate 402 may be separate components that are coupled or glued together or may be a single continuous component that is molded or fabricated from a single piece of material.

The angled portion 408 may connect the vertical portion 406 to the horizontal portion 410 and have a surface that is approximately 45 degrees relative to both the vertical portion 406 and the horizontal portion 410. The horizontal portion 410 may be connected to the base plate 402.

FIG. 5 illustrates a top front isometric view of an example of the sectional cable carrier guide 118. FIG. 5 illustrates a front of the vertical portion 406. The vertical portion 406 may include an opening 412. The opening 412 may have a “C” cross-sectional shape that is formed by three sides. The second end of the cable carrier 116 may be inserted into the opening 412 to be coupled to the sectional cable carrier guide 118.

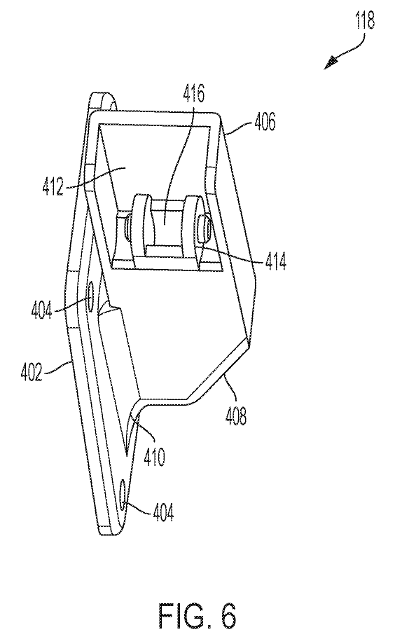

FIG. 6 illustrates a bottom front isometric view of the sectional cable carrier guide 118. FIG. 6 illustrates a cable carrier connection member 414 located inside of the opening 412. The cable carrier connection member 414 may include a shape and design to mechanically connect to the second end of the cable carrier 116.

In the example illustrated in FIG. 6, the cable carrier connection member 414 may include opposing arms with protruding tabs. The second end of the cable carrier 116 may include opposing arms with openings that correspond to the protruding tabs. The opposing arms of the second end of the cable carrier 116 may be mated with the opposing arms of the cable carrier connection member 414 such that the protruding tabs fit into the openings on the opposing arms of the second end of the cable carrier 116. However, other mechanical connections may also be used such as interlocking tabs, interference fits, and the like.

In one embodiment, the cable carrier connection member 414 may include an opening 416. The opening 416 may be located in a center of the cable carrier connection member 414. The opening 416 may allow an electric wire to be passed through the vertical portion 406, through the angled portion 408, the horizontal portion 410, and into the panel 104, for example through the end stile.

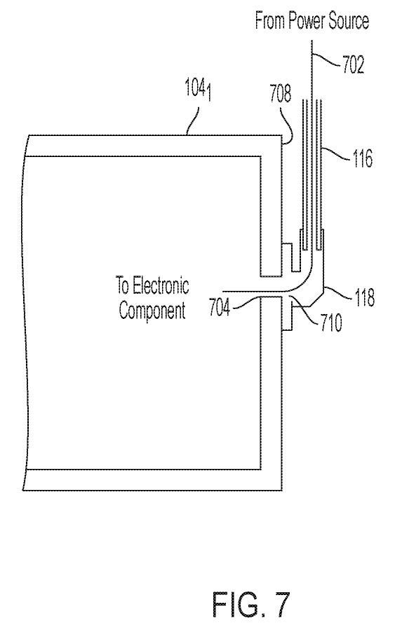

FIG. 7 illustrates a cut-away view of an example of the sectional cable carrier guide 118 and how a power cable 702 is fed into a top most panel 104₁. In one embodiment, the top most panel 104₁may include an opening 704 located on a side 708 of the top most panel 104₁. The side 708 may be an edge of the panel 104₁ that is located adjacent to the track 110.

The sectional cable carrier guide 118 may be coupled to the side 708 such that an opening 710 aligns with the opening 704 in the side 708 of the panel 104₁. The openings 404 of the base plate 402 may also be aligned with corresponding openings (not shown) in the side 708 of the panel 104₁such as an opening in the end stile.

FIG. 7 illustrates how the cable carrier 116 is connected to the sectional cable carrier guide 118 inside of the opening 412 of the vertical portion 406 of the sectional cable carrier guide 118. The power cable 702 is connected to the power source 122 and fed through the cable carrier 116, through the sectional cable carrier guide 118, through the opening 710 and into the top most panel 104₁through the opening 704. The power cable 702 may then be connected to an electronic component 108 in the top most panel 104₁or connected to an electric component 108 located in another panel to which the sectional cable carrier guide 118 is connected.

Referring back to FIG. 2, FIG. 2 illustrates how the cable carrier 116 is connected to the cable carrier track 114 and the sectional cable carrier guide 118. The cable carrier 116 may be positioned to be above a curved portion 152 of the track 110. It should be noted that the position of the cable carrier 116 should be such that the cable carrier 116 is not too high or too low. If the cable carrier 116 is too high, the cable carrier 116 may kink during operation of the sectional door 102. If the cable carrier 116 is too low, the cable carrier 116 may contact the track 110 interfering with proper operation of the sectional door 102. For example, the cable carrier 116 should be positioned such that a middle of the cable carrier 116 is a few centimeters (e.g., 2-10 cm) away from a midpoint of the curved portion 152 of the track 110.

The cable carrier 116 may also be connected such that cable carrier 116 is slightly curved. For example, a portion of the cable carrier 116 may have a curve that follows a curve of a curved portion 152 of the track 110.

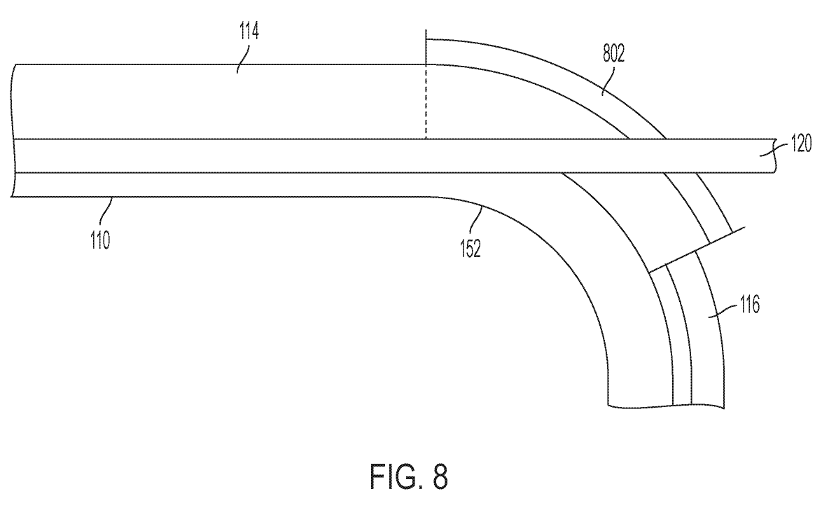

In one embodiment, the cable carrier track 114 may be modified to include a curved portion. FIG. 8 illustrates an example of the cable carrier track 114 with a curved portion 802. For example, the cable carrier track 114 may be extended to include the curved portion 802. The curved portion 802 may have a curvature that matches the curvature of the curved portion 152 of the track 110. The curved portion 802 of the cable carrier track 114 may further guide the movement of the cable carrier 116. The curved portion 802 may also prevent kinks from forming in the cable carrier 116 as the cable carrier 116 moves along with the movement of the sectional door 102.

In one embodiment, the cable carrier track 114 is connected to the tracks 110 or 112 that are vertically located on each side of the door sections. The sectional cable carrier guide 118 may be located on the bottom most panel 104ₙ.

In one embodiment, the cable carrier track 114 is connected to a garage door opener rail. The cable carrier track 114 should be mounted so as to not interfere with the operation of the chain, cable, or belt of the opener trolley.

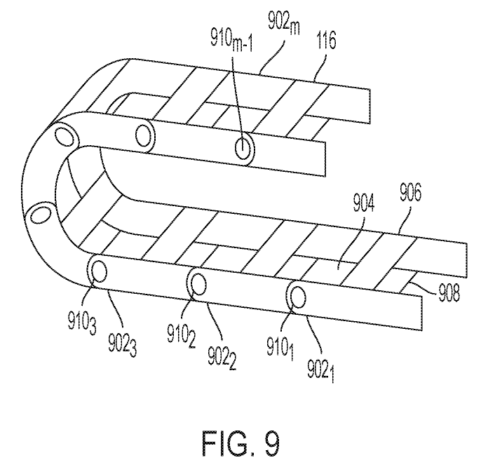

FIG. 9 illustrates an example of the cable carrier 116. The cable carrier 116 may be fabricated from metal or plastic. The cable carrier 116 may include sections 902₁to 902ₘ (hereinafter also referred to individually as a section 902 or collectively as sections 902) that are movably coupled together. Each section 902 may be connected via rotating couplings 910₁to 910ₘ₋₁ (hereinafter also referred to individually as a rotating coupling 910 or collectively as rotating couplings 910).

Each section 902 may include a bottom surface 904 and a top surface 906. Each end of each section 902 may include an interior volume 908. The power cable 702 may be fed through the interior volume 908 and pass through each section 902 of the cable carrier 116. The bottom surface 904 and the top surface 906 may support the power cable 702 within the cable carrier 116. The interior volume 908, comprising a height and a width, should be at least 10% larger than the diameter of the power cable 702.

It should be noted that FIG. 9 illustrates one example of a cable carrier 116. However, it should be noted that any type of cable carrier that can contain the power cable 702 may be used in the cable carrier assembly. Moreover, the dimensions of the cable carrier 116 (e.g., length, width, and height) may be a function of a size of the sectional door 102. For example, larger sectional doors 102 may have a cable carrier 116 with a larger length, width, and height. Smaller sectional doors may have a cable carrier 116 with a smaller length, width, and height.

In some embodiments, as the sectional door 102 is opened and closed, the sectional door 102 may shift laterally left or right. If the cable carrier 116 is directly coupled to the roller of the sectional door 102 the lateral shift may cause the cable carrier 116 to be misaligned or jammed.

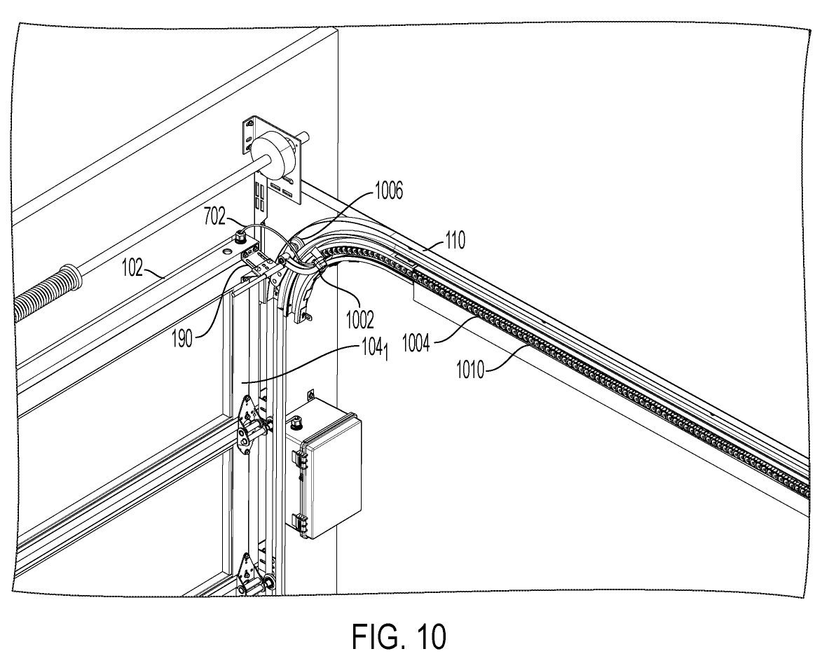

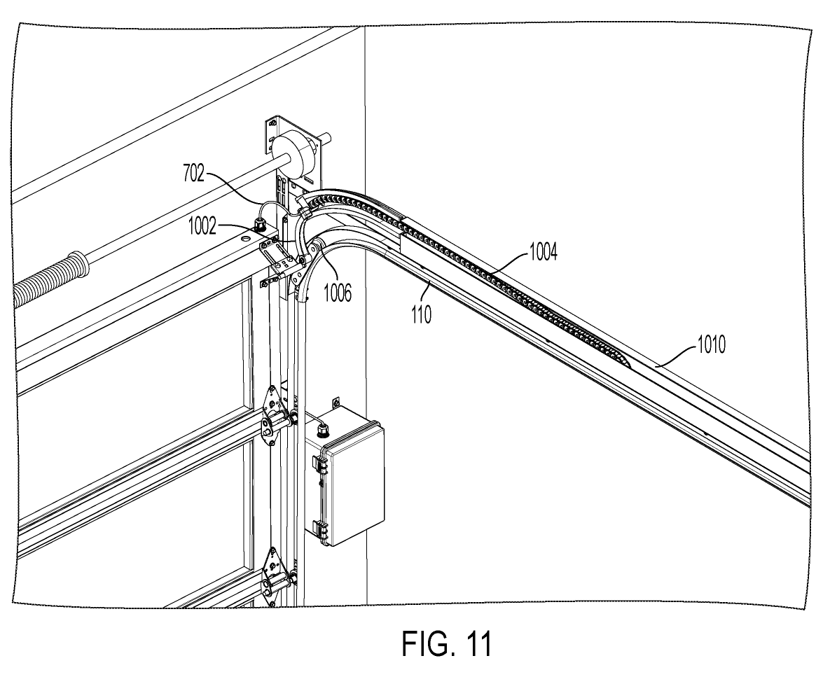

FIGS. 10-20 illustrate another embodiment where a floating tow arm 1002 may be used to reduce the complexity of the entire system. The floating tow arm 1002 may be designed to account for the lateral shift.

In one embodiment, the cable carrier 116 may be a cable chain 1004 that can carry the power cable 702 and is housed within a cable chain track 1010. The cable carrier 116 may be a separate track from the track 110. A floating tow arm 1002 may be connected to the chain and a roller connected to the top most panel 104₁. The floating tow arm 1002 may allow the chain to move as the sectional door 102 is moved.

FIG. 10 illustrates an isometric view of the floating tow arm 1002 in a first configuration. The first configuration may include the floating tow arm 1002 deployed in a first orientation such that the track 110 is deployed above the cable chain track 1010 that houses a cable chain 1004. The cable chain 1004 may house the power cable 702.

In one embodiment, the power cable 702 can be fed through part of the assembly of the floating tow arm 1002 and into the cable chain 1004. A first end of the floating tow arm 1002 may be pivotably coupled to the cable chain 1004 and a second end of the floating tow arm 1002 may be pivotably coupled to a roller. The pivotable couplings allow the floating tow arm 1002 to accommodate various positions of the cable chain 1004 and the roller.

FIG. 10 illustrates an example where the roller is a tandem roller 1006. The tandem roller 1006 may be coupled to the top most panel 104₁of the sectional door 102. The tandem roller 1006 may be connected to a hinge bracket 190 that is coupled to the top most panel 104₁.

As the sectional door 102 is opened and the tandem roller 1006 moves horizontally along the track 110, the tandem roller 1006 may move the floating tow arm 1002. As the floating tow arm 1002 is moved, the cable chain 1004 may also be moved (e.g., pushed or pulled) within the cable chain track 1010.

As a result, the cable chain 1004 is mechanically attached to the track 110 via the tandem roller 1006 making the cable chain 1004, the floating tow arm 1002, and the tandem roller 1006 one piece. The sectional door 102 is allowed to float on the axles of the rollers and can be moved closer or farther from the track 110 and the cable chain track 1010.

By mechanically attaching the floating tow arm 1002 to the tandem roller 1006, the distance uncertainty of the sectional door 102 from the track 110 and the cable chain track 1010 is eliminated. This results in the floating tow arm 1002 always being in optimal alignment with the cable chain track 1010. This will prevent the cable chain 1004 from coming out of the cable chain track 1010 or getting pushed into the cable chain track 1010 potentially causing damage or a malfunction.

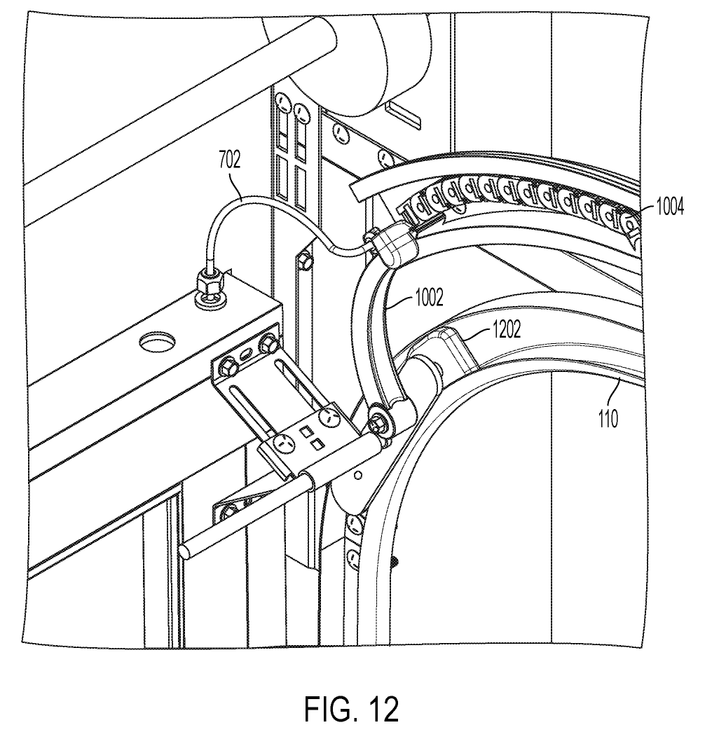

FIG. 11 illustrates an isometric view of the floating tow arm 1002 in a second configuration. The second configuration may include the floating tow arm 1002 deployed in a second orientation such that the track 110 is deployed below the cable chain track 1010.

FIG. 12 illustrates a close-up isometric view of the floating tow arm 1002 in the second configuration. In one embodiment, the tandem roller 1006 may be replaced with a gliding device 1202. In one embodiment, the gliding device 1202 may be located on both ends of the tandem roller 1006. In other words, there may be two gliding devices 1202, one on each end of the tandem roller 1006. The gliding device 1202 may function similarly to the tandem roller 1006 and move within the track 110. The gliding device 1202 may have a portion with a generally square or rectangular shape that moved within the track 110 without rotating.

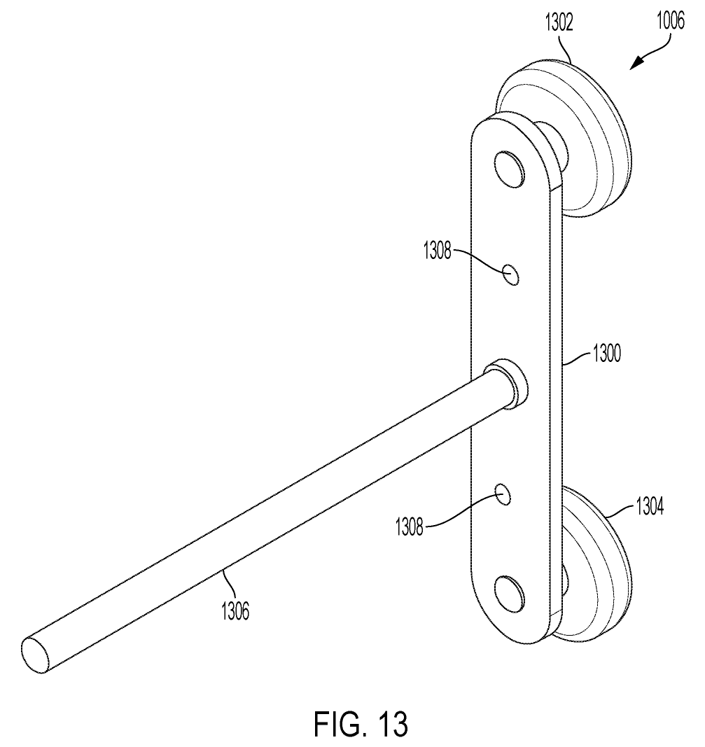

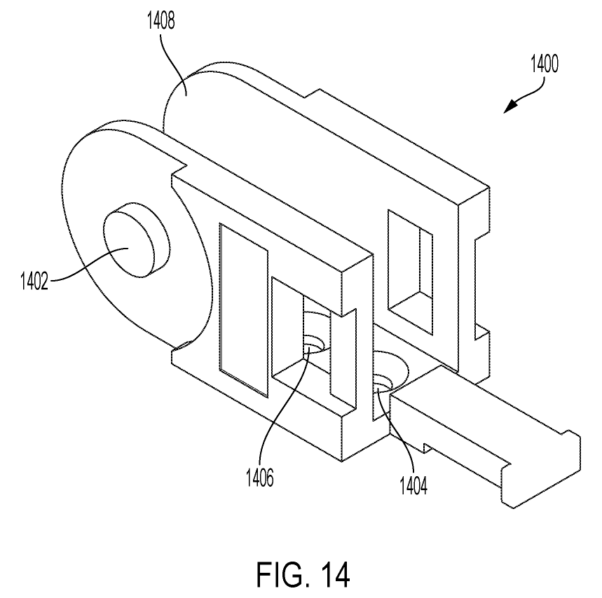

FIG. 13 illustrates an isometric view of an example tandem roller 1006 of the present disclosure. The tandem roller 1006 may include a body 1300. A first roller 1302 may be coupled to a first end of the body 1300 and a second roller 1304 may be coupled to a second end of the body 1300. The first roller 1302 and the second roller 1304 may be located within the track 110 and rotate as the tandem roller 1006 moves within the track 110.

A stem or bar 1306 may be coupled to the center of the body 1300 on a side that is opposite the first roller 1302 and the second roller 1304. The stem 1306 may provide a surface that can be secured in or coupled to the hinge bracket 190 to secure the tandem roller 1006 to the sectional door 102. In one embodiment, the body 1300 may also include an opening 1308 on either side of the stem 1306. In other words, a first opening 1308 may be located on a first side of the stem 1306 a second opening 1308 may be located on a second side of the stem 1306. The first opening 1308 and the second opening 1308 may be positioned equidistantly from the stem 1306.

This may allow the tandem roller 1006 to be used in either direction, or on either side of the door 102, such that a single tandem roller 1006 may be used for either configuration illustrated in FIGS. 10 and 11 above. This may also simplify the installation as a technician does not need to worry whether or not the tandem roller 1006 was installed in the correct orientation on either side of the door 102. A portion of the floating tow arm 1002 or assembly of the floating tow arm 1002 may be mechanically coupled to the body 1300 via the opening 1308.

FIG. 14 illustrates an isometric view of an example first cable chain piece 1400 of the present disclosure. The first cable chain piece 1400 may be mechanically coupled to the floating tow arm 1002 with fasteners via openings 1404 and 1406. The first cable chain piece 1400 may have a generally hollow body 1408 that has a cross-sectional “U” shape. The first cable chain piece 1400 may also include a connecting end that includes a protrusion 1402 that may be coupled to the cable chain 1004.

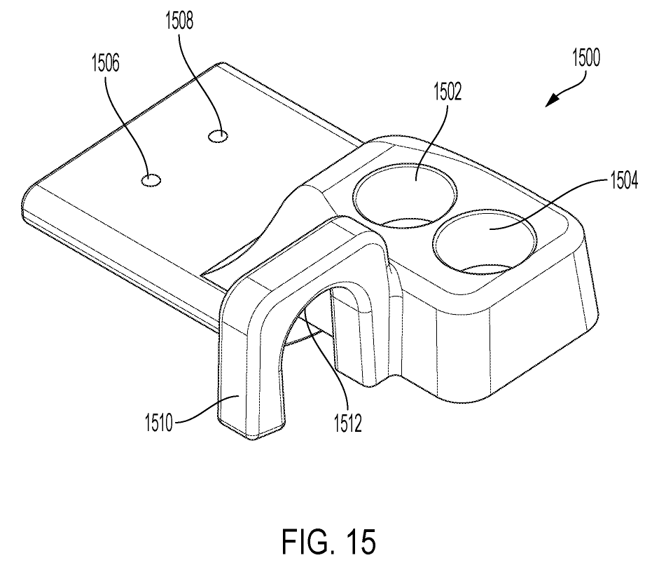

FIG. 15 illustrates an isometric view of an example cable chain attachment 1500 of the present disclosure. The cable chain attachment 1500 may include openings 1502 and 1504. Mechanical fasteners may be fitted through the openings 1502 and 1504 to couple the cable chain attachment 1500 to the floating tow arm 1002. The cable chain attachment 1500 may include openings 1506 and 1508 to receive mechanical fasteners to couple the first cable chain piece 1400 to the cable chain attachment 1500. In one embodiment, the openings 1506 and 1508 may be threaded.

In one embodiment, the cable chain attachment 1500 may include a grommet securing member 1510. The grommet securing member 1510 may have an interior surface that has an upside down “U” shape 1512. The grommet securing member 1510 may secure a grommet 1610 against the floating tow arm 1002.

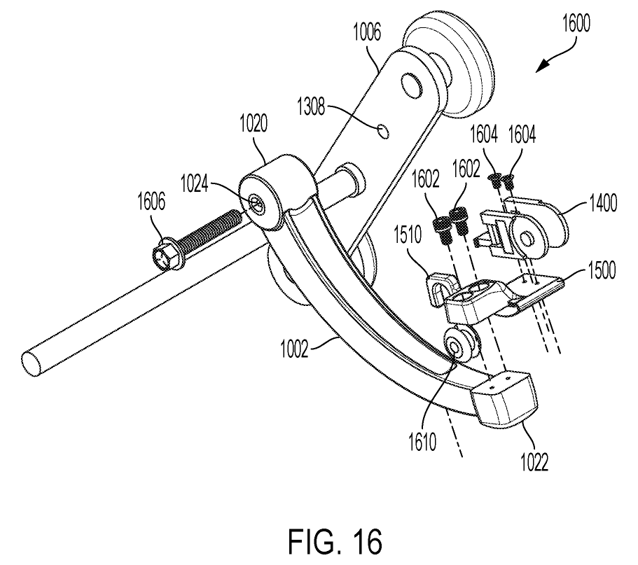

FIG. 16 illustrates an exploded view of a floating tow arm assembly 1600 in the first configuration with the tandem roller 1006. In one embodiment, the floating tow arm assembly 1600 may include the floating tow arm 1002 in the first orientation (e.g., a first end 1020 positioned above a second end 1022).

The cable chain attachment 1500 may be secured against the second end 1022 of the floating tow arm 1002 via mechanical fasteners 1602 (e.g., screws). The grommet securing member 1510 may enclose a grommet 1610 and secure the grommet 1610 within the interior surface 1512 of the grommet securing member 1510 and against the second end 1022 of the floating tow arm 1002. The first cable chain 1400 may be secured against the cable chain attachment 1500 via mechanical fasteners 1604 (e.g., screws). The grommet 1610 may allow the second end 1022 of the floating tow arm 1002 to pivot or rotate to accommodate various positions of the cable chain 1004. For example, the grommet 1610 may be fabricated from an elastomer and provide sufficient flexion or movement to accommodate minor angular changes of the floating tow arm 1002 as the door 102 moves.

The first end of the floating tow arm 1020 may be coupled to body 1300 of the tandem roller 1006 via a mechanical fastener 1606 (e.g., a bolt or a screw). The mechanical fastener 1606 may be threaded through the opening 1024 in the first end 1020 of the floating tow arm 1002 and through the opening 1308. In one embodiment, the opening 1024 may include a steel insert to provide a bearing surface for the mechanical fastener 1606. The mechanical fastener 1606 may pivotably coupled to the first end 1020 of the floating tow arm 1002 to allow the first end 1020 to rotate as the position of the tandem roller 1006 changes along the track 110.

It should be noted that the diameter of the openings 1024 and 1308 may not be drawn to scale. For example, the diameter of the opening 1308 may be the same as the diameter of the opening 1024 to accommodate the diameter of the mechanical fastener 1606.

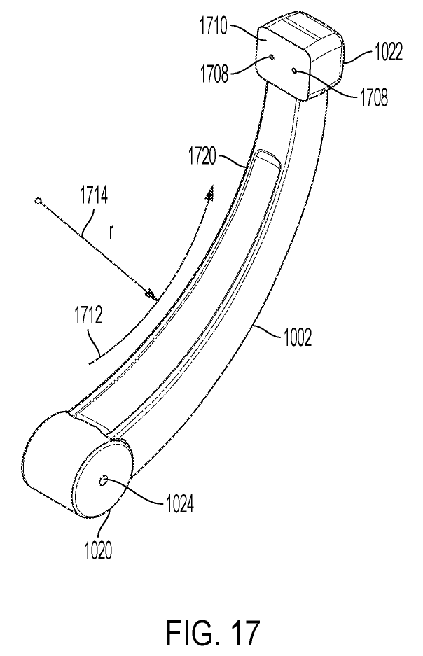

FIG. 17 illustrates an isometric view of the floating tow arm 1002. In one embodiment, the floating tow arm 1002 may have a curved body portion 1720. The curved body portion 1720 may have a curvature 1712 defined by a radius of curvature 1714. In one embodiment, the first end 1020 may have an opening 1024. As noted above, the diameter of the opening 1024 may not be drawn to scale.

In one embodiment, the second end 1022 may include openings 1708 in a surface 1710. The diameter of the openings 1708 may not be drawing to scale. However, the diameter of the openings 1708 may sized to receive the mechanical fasteners 1602 illustrated in FIG. 16.

In one embodiment, the surface 1710 may also be a flat or planar surface. The flat or planar surface of a portion of the cable chain attachment 1500 that includes the openings 1502 and 1504 may rest flush against the surface 1710.

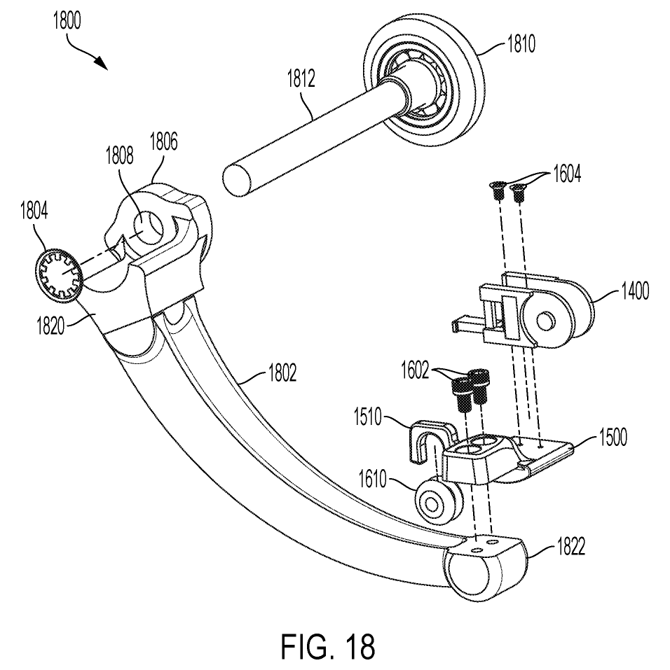

FIG. 18 illustrates an exploded view of another example floating tow arm assembly 1800 in the first configuration with a single roller 1810. In one embodiment, the floating tow arm assembly 1800 may include a floating tow arm 1802 with a first end 1820 and a second end 1822. The second end 1822 may be similar to the second end 1022 to receive the grommet 1610, the cable chain attachment 1500 and the first cable chain 1400, as described above and illustrated in FIG. 16.

However, the first end 1820 may be modified to accommodate the single roller 1810. The first end 1820 may include a vertical member 1806 with an opening 1808. A stem 1812 of the single roller 1810 may be inserted through the opening 1808 and fitted through a bushing 1804. The stem 1812 may then be secured against the top most panel 104₁via the hinge bracket 190.

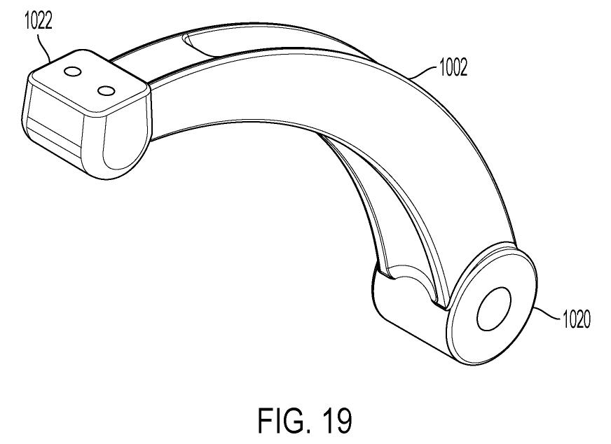

FIG. 19 illustrates an isometric view of the floating tow arm 1002 in a second orientation of the present disclosure. In the second orientation, the second end 1022 of the floating tow arm 1002 may be positioned to be above the first end 1020. As a result, the floating tow arm 1002 may be coupled to the cable chain 1004 that is located above the track 110.

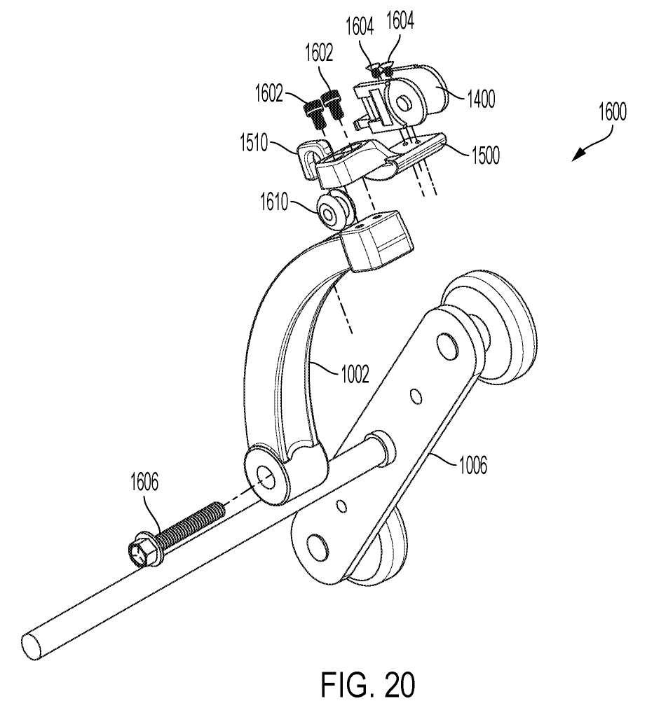

FIG. 20 illustrates an exploded view of the example floating tow arm assembly 1600 in the second configuration with the floating tow arm 1002 in the second orientation illustrated in FIG. 19. The assembly of the floating tow arm 1002 to the tandem roller 1006, the cable chain attachment 1500, and the first cable chain 1400 may be similar to that shown in FIG. 16, and described above.

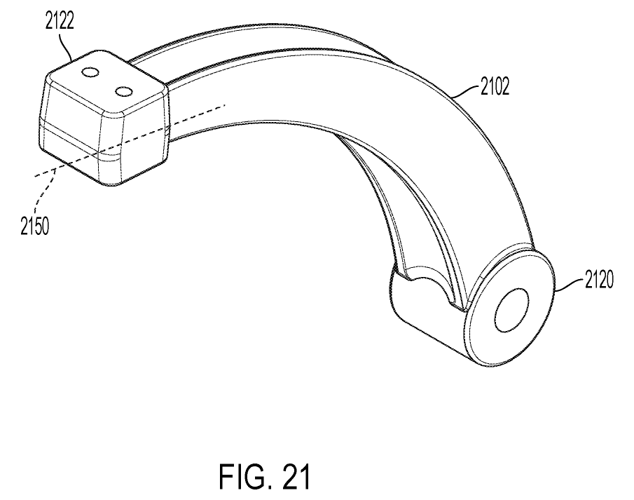

FIG. 21 illustrates an isometric view of another example of a floating tow arm 2102 of the present disclosure. In one embodiment, the floating tow arm 2102 may be identical to the floating tow arm 1002 in all respects except for the design of the second end 2122. The floating tow arm 2102 may have a first end 2120 that is identical to the first end 1020 of the floating tow arm 1002 with the same openings (e.g., the opening 1024 of the first end 1020 illustrated in FIG. 17). The floating tow arm 2102 may also have a curved body portion similar to the curved body portion 1720 defined by a radius of curvature 1714. In other words, the only difference between the floating tow arm 2102 and the floating tow arm 1002 may be the second end 2122.

In one embodiment, the second end 2122 may be designed to have a shape that is mirrored about a plane or line 2150 that is a middle of the second end 2122. Said another way, if the second end 2122 were sliced in half along the line 2150, each half of the second end 2122 would be identical.

Since the shape of the second end 2122 may be symmetrical, the floating tow arm 2102 may be used for either configuration illustrated in FIGS. 10 and 11, and discussed above. As a result, only a single floating tow arm 2102 may be kept in inventory to reduce inventory costs and allow for more efficient installation.

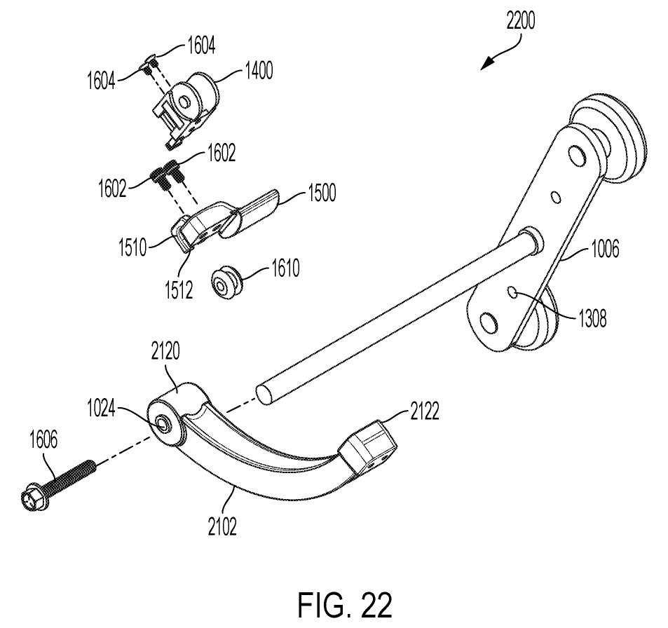

FIG. 22 illustrates an exploded view of an example floating tow arm assembly 2200 that uses the floating tow arm 2102. The cable chain attachment 1500 may be secured against the second end 2122 of the floating tow arm 2102 via mechanical fasteners 1602 (e.g., screws). The grommet securing member 1510 may enclose a grommet 1610 and secure the grommet 1610 within the interior surface 1512 of the grommet securing member 1510 and against the second end 2122 of the floating tow arm 2102. The first cable chain 1400 may be secured against the cable chain attachment 1500 via mechanical fasteners 1604 (e.g., screws). The grommet 1610 may allow the second end 2122 of the floating tow arm 2102 to pivot or rotate to accommodate various positions of the cable chain 1004.

The first end of the floating tow arm 2120 may be coupled to body 1300 of the tandem roller 1006 via a mechanical fastener 1606 (e.g., a bolt or a screw). The mechanical fastener 1606 may be threaded through the opening 1024 in the first end 2120 of the floating tow arm 2102 and through the opening 1308. In one embodiment, the opening 1024 may include a steel insert to provide a bearing surface for the mechanical fastener 1606. The mechanical fastener 1606 may be pivotably coupled to the first end 2120 of the floating tow arm 2102 to allow the first end 2120 to rotate as the position of the tandem roller 1006 changes along the track 110.

It should be noted that the diameter of the openings 1024 and 1308 may not be drawn to scale. For example, the diameter of the opening 1308 may be the same as the diameter of the opening 1024 to accommodate the diameter of the mechanical fastener 1606.

Thus, the present disclosure provides a cable carrier assembly for sectional doors that allows power cables or electrical wiring to be properly connected to one or more panels of the sectional door. The cable carrier assembly may prevent power cables or electrical wiring to the panels of the sectional door from interfering with the operation of the sectional door. As a result, sectional doors may have continuous power delivered to electronic components within the panel that may require continuous power.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

1. A floating tow arm for a floating tow arm assembly of an overhead door, comprising:
a curved body comprising:
a first end comprising a first opening to receive a first mechanical fastener to couple at least one roller to the first end; and
a second end comprising one or more second openings to receive second mechanical fasteners to couple a cable chain attachment to the second end.

2. The floating tow arm of claim 1, wherein the first opening comprises a steel insert to provide a bearing surface for the first mechanical fastener.

3. The floating tow arm of claim 1, wherein the second end comprises a first orientation for a first configuration of the floating tow arm assembly, wherein the first end is positioned above the second end.

4. The floating tow arm of claim 1, wherein the second end comprises a second orientation for a second configuration of the floating tow arm assembly, wherein the second end is positioned above the first end.

5. The floating tow arm of claim 1, wherein the second end comprises a symmetrical shape that is mirrored about a plane in a middle of the second end.

6. The floating tow arm of claim 1, wherein the at least one roller comprises a single roller or a tandem roller.

7. A floating tow arm assembly for an overhead door, comprising:
a floating tow arm comprising a first end and a second end;
a tandem roller coupled to the first end of the floating tow arm; and
a cable chain attachment coupled to the second end of the floating tow arm.

8. The floating tow arm assembly of claim 7, wherein the tandem roller comprises:
a body;
a stem located at a center of the body, wherein the stem is to be inserted in a hinge bracket of a top most panel of the overhead door;
a first opening in the body on a first side of the stem; and
a second opening in the body on a second side of the stem, wherein the stem is located between the first opening and the second opening and the first opening and the second opening are positioned equidistantly from the stem, wherein the first opening or the second opening is to receive a mechanical fastener to couple the tandem roller to a first end of the floating tow arm.

9. The floating tow arm assembly of claim 8, wherein the tandem roller further comprises:
a first roller on a first end of the body; and
a second roller on a second end of the body.

10. The floating tow arm assembly of claim 8, wherein the tandem roller further comprises:
a first gliding device on a first end of the body; and
a second gliding device on a second end of the body.

11. The floating tow arm assembly of claim 7, wherein the cable chain attachment, comprises:
at least one first opening to receive one or more first mechanical fasteners to couple the cable chain attachment to the second end of the floating tow arm;
at least one second opening to receive one or more second mechanical fasteners to couple a first cable chain piece to the cable chain attachment; and
a grommet securing member to secure a grommet against the floating tow arm.

12. The floating tow arm assembly of claim 11, wherein the grommet securing member comprises a “U” shape to receive the grommet.

13. The floating tow arm assembly of claim 7, wherein the second end of the floating tow arm comprises a symmetrical shape that is mirrored about a plane in a middle of the second end.

14. A door assembly, comprising:
an overhead door comprising a plurality of panels;
a first track to guide movement of the overhead door;
a cable chain track to guide movement of a cable chain to carry power cables for providing a constant power source to an electrical component that is integrated into a panel of the plurality of panels; and
a floating tow arm assembly coupled to a hinge bracket of a top most panel of the plurality of panels and the cable chain.

15. The door assembly of claim 14, wherein the floating tow arm assembly, comprises:
a floating tow arm comprising a first end and a second end;
a tandem roller coupled to the first end of the floating tow arm; and
a cable chain attachment coupled to the second end of the floating tow arm.

16. The door assembly of claim 15, wherein the tandem roller comprises:
a body;
a stem located at a center of the body, wherein the stem is inserted into the hinge bracket of the top most panel of the plurality of panels;
a first opening in the body on a first side of the stem; and
a second opening in the body on a second side of the stem, wherein the stem is located between the first opening and the second opening and the first opening and the second opening are positioned equidistantly from the stem, wherein the first opening or the second opening is to receive a mechanical fastener to couple the tandem roller to a first end of the floating tow arm.

17. The door assembly of claim 16, wherein the tandem roller further comprises:
a first roller on a first end of the body; and
a second roller on a second end of the body, wherein the first roller and the second roller travel within the first track.

18. The door assembly of claim 15, wherein the cable chain attachment, comprises:
at least one first opening to receive one or more first mechanical fasteners to couple the cable chain attachment to the second end of the floating tow arm;
at least one second opening to receive one or more second mechanical fasteners to couple a first cable chain piece of the cable chain to the cable chain attachment; and
a grommet securing member to secure a grommet against the floating tow arm.

19. The door assembly of claim 15, wherein the second end of the floating tow arm comprises a symmetrical shape that is mirrored about a plane in a middle of the second end.

20. The door assembly of claim 14, wherein the floating tow arm assembly provides lateral tolerance between the overhead door and the cable chain track while the overhead door is moving.
